(19) United States
(12) Patent Application Publication
(10) Pub. No.: US 2003/0021450 A1
(43) Pub. Date: Jan. 30, 2003

(54) Fingerprint imaging device

(76) Inventors: Yury Shapiro, San Ramon, CA (US); Alexandre Ryabov, Gagrebssky (RU)

Correspondence Address: FISH & RICHARDSON P.C., 500 ARGUELLO STREET, SUITE 500, REDWOOD CITY, CA, 94063, US

(21) Appl. No.: 09/916,219

(22) Filed: Jul. 27, 2001

(51) Int. Cl. G06K 9/00

(52) U.S. Cl. 382/124

(57) ABSTRACT

An imaging device includes an optical plate made of an optically transparent material and forming a surface for receiving a finger. The imaging device includes a light source and an imaging system. The light source is positioned to illuminate the finger receiving surface. The imaging system is positioned to receive light collected from the finger receiving surface and to form an image of a fingerprint pattern of the finger based on the received light. To reduce a thickness of the optical plate, the optical plate may have an index of refraction less than 1.49. In another design to reduce the thickness of the optical plate, the optical plate may have an index of refraction less than the index of refraction of finger skin. The optical plate may be made of a silicone material.

### TECHNICAL FIELD

This invention relates to fingerprint imaging devices and methods of imaging fingerprints.

### BACKGROUND

Referring to FIG. 1, one type of fingerprint imaging device 100 includes a transparent optical plate 105 (for example, a prism) having a surface 107 exposed to air, a light source 110 located to the side of or near the optical plate 105, and an imaging system 112. The imaging system 112 includes an aperture 115, an objective 120, and some type of detector 125 (for example, a CCD or a CMOS camera). The interface between the surface 107 and the air is defined by a critical angle θ_{CR}, which is the smallest angle of incidence for which light striking the interface is totally internally reflected within the surface 107. The critical angle θ_{CR} at this interface depends on the indices of refraction of the air and the optical plate 105. The size of the surface 107 is typically greater than or equal to about 16 millimeters (mm) in both dimensions to enable accurate fingerprint identification. In one implementation, the surface 107 is about 18 mm in length and about 18 mm in width. For further reference, directions x and y of the orthogonal coordinate system are shown by arrows. A third direction z of this orthogonal coordinate system is perpendicular to the drawing plane of FIG. 1.

Referring also to FIG. 2, in operation, a finger 200 to be imaged is placed on the surface 107 and is illuminated by the light source 110 near the optical plate 105. Light from the light source 110 is incident on the surface 107 of the optical plate 105 at an angle of incidence measured with respect to a normal to the surface 107. Light from the light source 110 that strikes the surface 107 at an angle greater than the critical angle θ_{CR} is totally internally reflected from the surface 107.

As shown, the finger 200 includes a series of ridges 205 and intermediate valleys 210. Thus, when the finger 200 is applied to the surface 107, the ridges 205 contact the surface 107 of the optical plate 105 while the valleys 210 do not. Thus, the valleys 210 serve to form the pockets or regions of air and/or moisture. Some light rays 215 strike a portion of the surface 107 that is contacted by a ridge 205. Those light rays 215 are diffused because the index of refraction of the finger 200 is larger than the index of refraction of air. Some light rays 220 strike a portion of the surface 107 that is not contacted by a ridge 205 but is instead contacted by the pocket of air and/or moisture formed by a valley 210. If the angle of incidence of those light rays is greater than the critical angle, then those light rays 220 are reflected from the surface 107 and reach the imaging system 112. In this way, the imaging system 112 detects a dark fingerprint image formed on a light background, called a positive image.

Referring to FIG. 3, another type of fingerprint imaging device 300 includes a transparent optical plate 305 (similar to optical plate 105) having a surface 307 exposed to air, one or more light sources 310 (similar to light source 110) located generally below the surface 307 of the optical plate 305, and an imaging system 312. The imaging system 312 includes an aperture 315 (similar to aperture 115), an objective 320 (similar to objective 120), and some type of detector 325. The interface between the surface 307 and the air is defined by the critical angle θ_{CR}, which, as discussed above, is the smallest angle of incidence for which light striking the interface is totally internally reflected. The critical angle θ_{CR} at this interface depends on the indices of refraction of the air and the optical plate 305. The aperture 315 and objective 320 are configured to view the surface 307 at an angle greater than the critical angle θ_{CR}.

Referring also to FIG. 4, in operation, the finger 200 to be imaged is placed on the surface 307 and is illuminated by the one or more light sources 310. Light from a light source 310 is incident on the surface 307 of the optical plate 305 at an angle of incidence measured with respect to a normal to the surface 307. As discussed above, light from a light source 310 that strikes the surface 307 at an angle greater than the critical angle θ_{CR} is totally internally reflected from the surface 307. Some light rays strike a portion of the surface 307 that is contacted by a ridge 205. Those light rays are diffused and reflected because the index of refraction of the finger 200 is larger than the index of refraction of air. Thus, these light rays reach the detector 325.

Some light rays strike a portion of the surface 307 that is not contacted by a ridge 205 but is instead contacted by the pocket of air and/or moisture formed by a valley 210. However, because of the location of the light sources 310 relative to the optical plate surface 307, the light striking the surface 307 enters at an angle of incidence that is less than the critical angle θ_{CR}. Accordingly, those light rays 220 are refracted through the surface 307, exit through the optical plate 305, and do not reach the detector 325. In this way, the detector 325 detects a light fingerprint image formed on a dark background, called a negative image.

Examples of fingerprint imaging devices are described in U.S. Pat. No. 4,924,085 to Kato et al.; U.S. Pat. No. 5,596,454 to Hebert; and U.S. Pat. No. 5,796,858 to Zhou et al. The size of the fingerprint imaging devices described in these patents exceeds the minimum require size of the finger receiving surface. Furthermore, the fingerprint imaging devices described in these patents are relatively thick, thus making it difficult to use these devices in portable or compact electronic apparatus.

### SUMMARY

In one general aspect, an imaging device includes an optical plate made of an optically transparent material and forming a surface for receiving a finger. The imaging device includes a light source and an imaging system. The light source is positioned to illuminate the surface. The imaging system is positioned to receive light collected from the surface and to form an image of a fingerprint pattern of the finger based on the received light. The optical plate has an index of refraction less than 1.49.

Implementations may include one or more of the following features. For example, the optical plate material may include TPX, Butyrate, or silicone. The optical plate may include a second surface at which the light source may be positioned. The optical plate may include a third surface that is reflective and that collects light from the surface and focuses the collected light on the imaging system. The optical plate may include a fourth surface at which the imaging system may be positioned.

The optical plate may have an index of refraction less than 1.44. In this case, the optical plate may be made of a silicone material.

The imaging system may include an aperture at the second surface, an objective at the aperture, and a detector for receiving light collected by the aperture and the objective to form the image of the fingerprint pattern. The imaging system may include a reflective surface positioned between the objective and the detector for collecting light from the objective and for focusing the light onto the detector.

The detector may include a CCD or a CMOS sensor. The aperture may define an aperture beam of light rays used by the detector to form the fingerprint pattern image.

In another general aspect, a method of forming an optical plate includes molding a silicone material into a base, forming a reflective device, and attaching the reflective device to the base to form a reflective interface between the base and the reflective device.

In another general aspect, a method of forming an optical plate includes forming a transparent hollow device having three sides and applying a coating to an inner surface of one of the sides to form a reflective surface on that side. The method also includes dispensing silicone material into the hollow device and hardening the silicone material to form the optical plate.

Aspects of the devices and systems can include one or more of the following advantages. The fingerprint imaging device maybe used in portable or compact electronic apparatus because the size of the fingerprint imaging device can be reduced further without sacrificing fingerprint imaging quality.

The details of one or more implementations are set forth in the accompanying drawings and the description below. Other features and advantages will be apparent from the description, the drawings, and the claims.

### DESCRIPTION OF DRAWINGS

FIGS. 1-4 show fingerprint imaging devices known in the art.

FIGS. 5 and 6 show side sectional views of a fingerprint imaging device for use in an electronic apparatus.

FIGS. 7 and 8 show techniques for making an optical plate that may be used in the fingerprint imaging device of FIG. 5 or 6.

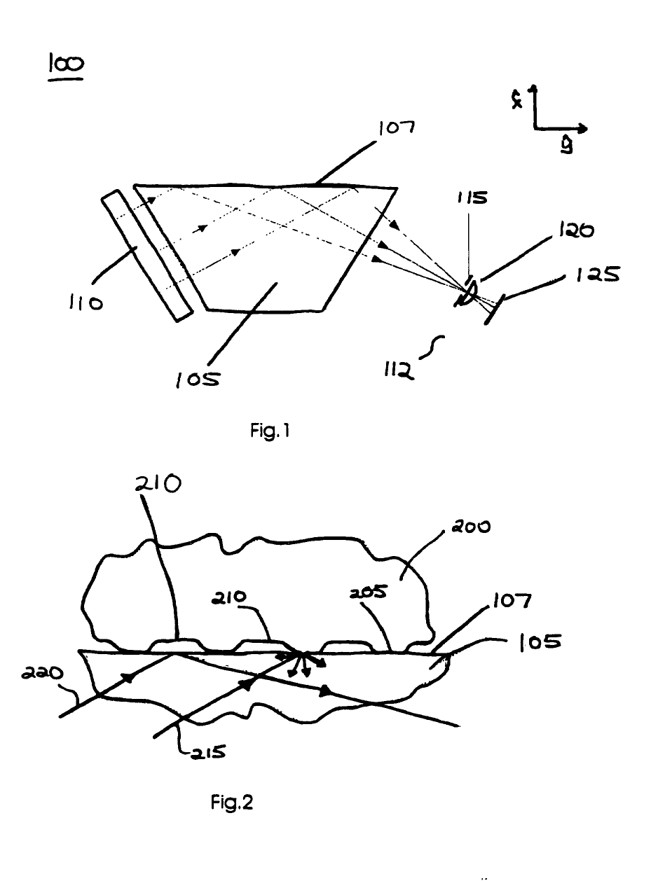

Like reference symbols in the various drawings indicate like elements.

### DETAILED DESCRIPTION

A fingerprint imaging device is designed with a reduced size with acceptable fingerprint image quality. Such a design may be useful not only in a standard imaging configuration, but also in a compact imaging configuration often incorporated into portable or compact electronic apparatus. Examples of portable or compact electronic apparatus include mobile telephones such as cellular or cordless telephones, personal computers such as portable computers, personal digital assistants, pagers, and remote control systems. Moreover, to reduce cost, the fingerprint imaging device may be built into the electronic apparatus with substantially no changes in the design of these apparatus.

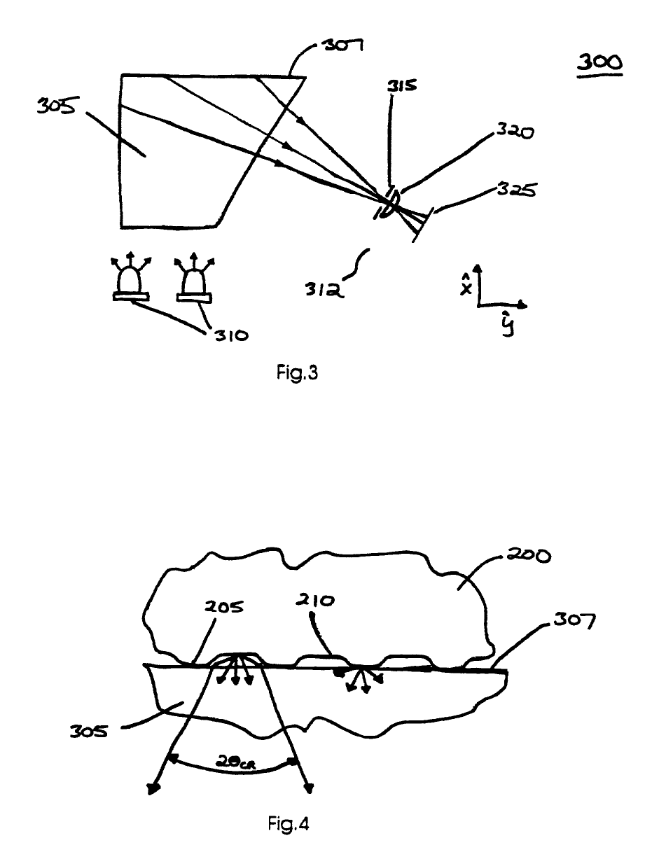

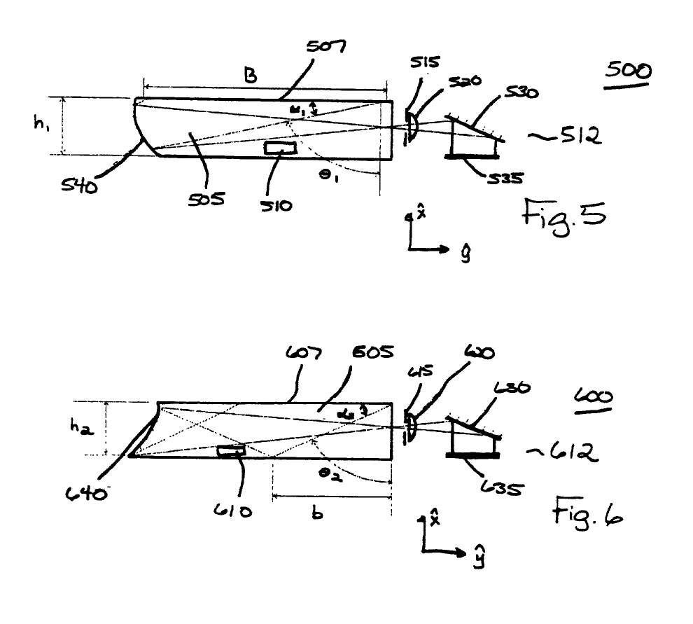

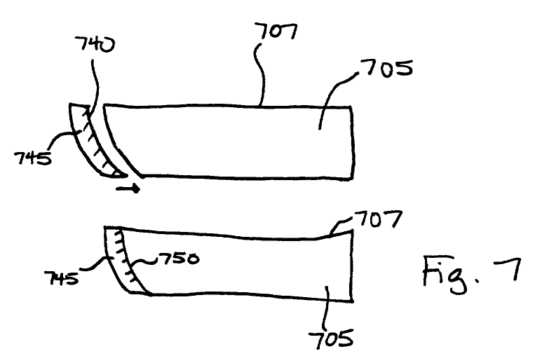

Referring to FIG. 5, in one implementation, a fingerprint imaging device 500 that produces a negative image, that is, a light fingerprint image on a dark background (similar in operation to the device 300 of FIGS. 3 and 4) includes an optical plate 505 having a surface 507 exposed to air and designed to receive a finger, one or more light sources 510 located along a lateral surface of the optical plate 505, and an imaging system 512. The fingerprint imaging device 500 produces a fingerprint pattern formed by regions of contact of finger skin ridges with the surface 507 of the optical plate 505. The imaging system 512 includes an aperture 515 located at another lateral surface, an objective 520, a reflective surface 530, such as a mirror, and some type of detector 535 for receiving light collected from the aperture 515 and the objective 520. The objective 520 is positioned to focus the reflected and/or diffused light rays from the surface 507 on the detector 535. The optical plate 505 also includes a reflective surface 540 such as a converging mirror positioned on another lateral surface of the optical plate 505 and opposite to the aperture 515.

The one or more light sources 510 may be arranged and operated to illuminate the surface 507. A light source 510 may be positioned at two opposite lateral surfaces of the optical plate 505. The light sources 510 may emit light in any wavelength region suitable for fingerprint imaging. In one implementation, the light sources 510 may be conventional light-emitting diodes emitting light in the red spectral region. In another implementation, the light sources 510 may emit evenly throughout a wide spectral range.

The reflective surface 530 may be any mirror coated to reflect light of a wavelength produced by the one or more light sources 510. The detector 535 may be, for example, a single crystal CMOS image sensor, produced by Motorola Co., Inc, or it may be a conventional array CCD. The optical plate 505, light sources 510, and detector 535 are chosen based on their various optical properties to provide the information needed to obtain fingerprint imaging results. Thus, for example, the optical plate 505 is selected based on its index of refraction and spectral transmission properties. The light sources 510 are selected based on their spectral emission and intensity properties. The detector 535 is selected based on its spectral detection, radiation intensity, and radiation sensitivity properties.

The objective 520 may include, for example, a lens such as a planoconvex lens, which provides reasonable image quality at a reasonable cost. Alternatively, to reduce non-planarity of the image surface (which may arise when using the planoconvex lens), the objective 520 may include a bi-concave or convexo-concave lens.

The surface 507 may be a smooth surface to provide good contact with the finger skin ridges. In any case, the surface 507 has dimensions that are sufficient for reliable identification of the fingerprint pattern. In other words, the surface 507 has dimensions sufficient to provide a number of ridge comparisons that enable reliable fingerprint identification. For example, the number of ridge comparisons may range anywhere from about 8 to about 16.

The reflective surface 540 may have a reflecting coating, which, for example, may be a deposited layer of aluminum. The reflective surface 540 may be made spherical to approximate a theoretically preferred parabolic or hyperbolic form. The reflective surface 540 may have a radius of curvature of about 36 mm and a center of curvature being offset by about 5 millimeters (mm) up from the center of the optical plate 505 along the x direction.

The objective 520 may have its object side focal point located approximately at the focal plane of the reflective surface 540. In this way, the objective 520 and the reflective surface 540 form an afocal optical system that may be physically adjusted to receive a substantially parallel beam of the light rays from the surface 507. Such an afocal optical system provides an image of the fingerprint pattern with minor geometric distortion notwithstanding high values of an angle of observation. The object side focal point of the objective 520 may be located at a distance of about 1.5 mm from its plane surface facing the lateral surface at which the aperture is located.

The reflective surface 540 may be adjusted to receive substantially parallel light rays (along an observation path), which are traveling from the surface 507 at an angle θ₁ with respect to the normal of the surface 507. The reflective surface 540 reflects the light rays through the optical plate 505 to the objective 520 as a converging beam. The objective 520 projects the fingerprint pattern image outside the optical plate 505 to the reflective surface 530. The reflective surface 530 directs the light rays emerging from the objective 520 to the detector 535. The detector 535 detects light rays that are incident on the reflective surface 540 and reflected from the surface 540.

The surface 507 and the air interface is defined by a critical angle θ_{CR1}, which is the angle of incidence for which light striking the surface/air interface is totally internally reflected within the optical plate 505. The critical angle θ_{CR1} depends on the indices of refraction of the air and the optical plate 505. The value of the critical angle θ_{CR1} may be given by Snell's Law as:

$$sin ( {θ}_{CR1} ) = \frac{{n}_{2}}{{n}_{1}} ,$$

where n₁ is the index of refraction of the optical plate 505 and n₂ is the index of refraction of air. Thus, in prior fingerprint imaging devices, if the optical plate 505 were made of acrylic, which has an index of refraction of 1.49, then the critical angle θ_{CR1} would be 42°. In that case, the angle of incidence (relative to the normal of the surface 507) of light striking the surface 507 need be less than 42° to permit fingerprint imaging of the fingerprint pattern. Accordingly, to produce a negative image of the fingerprint pattern, light should generally strike the surface 507 at an angle less than the value of the critical angle θ_{CR1}. Additionally, the surface 507 and the finger ridge interface is defined by a critical angle θ_{CR2}, which is the angle of incidence for which light striking the surface/ridge interface is totally internally reflected within the optical plate 505. Like critical angle θ_{CR1}, critical angle θ_{CR2} depends on the indices of refraction of the finger skin and the optical plate 505. The value of the critical angle θ_{CR2} may be given by Snell's Law as:

$$sin ( {θ}_{CR2} ) = \frac{{n}_{3}}{{n}_{1}} ,$$

where n₁ is the index of refraction of the optical plate 505 and n₃ is a measure of the index of refraction of the finger. Thus, if the finger skin has an index of refraction of 1.44, which may be determined experimentally, then the critical angle θ_{CR2} is 75.1°. To permit negative fingerprint imaging of the fingerprint pattern, an angle of observation α₁ relative to the surface 507 (which is 90°−θ_{1,2}) must be greater than a critical observation angle α_{CR}, which equals 90°−θ_{CR2}.

The optical plate 505 has a thickness h₁ that is measured along the x direction. This thickness h₁ is related to the angle θ₁ such that a light ray coming from a border of the surface 507 farthest from the reflective surface 540 must be captured by the reflective surface 540. As mentioned above, the angle θ₁ is related to the angle of observation α₁ by: θ₁=90°−α₁.

Referring also to FIG. 6, a fingerprint imaging device 600 is designed in many respects like the device 500. The device 600 has an optical plate 605 having a surface 607, one or more light sources 610 located along a lateral surface of the optical plate 605, and an imaging system 612. The imaging system 612 includes an aperture 615 located at another lateral surface of the optical plate 605, an objective 620, a reflective surface 630 such as a mirror, and a detector 635. The optical plate 605 also includes a reflective surface 640 positioned on another lateral surface of the optical plate 605 and opposite to the aperture 615. Unlike the optical plate 505, the reflective surface 640 may be a diverging mirror.

In operation, when a finger is applied to the surface 507 or 607, light rays from the light sources 510 or 610 penetrate through the surface 507 or 607 and illuminate the finger at its ridges in those portions of the surface 507 or 607 that are contacted by the ridges of the finger. Light rays diffused from the ridges pass through the optical plate 505 and 605 in accordance with the refraction law at angles to the normal of the surface not exceeding the critical angle θ_{CR2} at the interface with the ridges. These light rays create a negative fingerprint pattern formed by the bright regions corresponding to the ridges of the finger skin because the valleys of the finger skin produce a dark background. In this way, the imaging system 512 or 612 detects a light fingerprint image formed on a dark background.

To reduce the thickness h₁ or h₂ of the device 500 or 600, the observation angle α₁ or α₂ should be decreased. Therefore, the angle θ₁ or θ₂ should be increased (because θ_{1,2}=90°−α_{1,2}) as shown in FIGS. 5 and 6. However, if the angle θ₁, θ₂, exceeds the critical angle θ_{CR2}, the fingerprint image disappears.

In prior fingerprint imaging devices, if the optical plate is made of acrylic plastic having an n₂=1.49 and if the measure of the index of refraction of the finger n₂=1.44, then the observation angle α_{1,2} has a minimum value of 14.9°, which is the critical observation angle α_{CR} (or 90°−θ_{CR2}).

For device 500 having a reflective surface 540 that is a converging mirror, the minimum thickness hi is related to the critical observation angle α_{CR} by the following general relationship:

$$tan ( {α}_{CR} ) = \frac{{h}_{1}}{B} ,$$

where B is a length of the fingerprint that can be captured. Thus, for example, if B=16 mm and if α_{CR}=14.9° (for prior fingerprint imaging devices made of acrylic), then the minimum thickness h₁=4.26 mm.

In the device 600, a double reflection occurs due to the use of the reflective surface 640 that is a diverging mirror. Such a design allows a further reduction of the thickness of the device 600. In this case, the minimum thickness h₂ is related to the critical observation angle α_{CR} by the following general relationship:

$$tan ( {α}_{CR} ) = \frac{{h}_{2}}{b} ,$$

where b is a length of the fingerprint that can be captured. Thus, if b=13.5 mm and if α_{CR}=14.9° (for prior fingerprint imaging devices made of acrylic), then the minimum thickness h₂=3.6 mm.

In one implementation, the optical plate 505 or 605 may be made using a material having an index of refraction n₁ less than that of acrylic plastic (which is used in prior fingerprint imaging devices), which has an index of refraction equal to 1.49. In this way, the size or thickness h of the optical plate may be reduced because the critical observation angle α_{CR} is reduced due to an increase in the critical angle θ_{CR2}. For example, the optical plate 505 or 605 may be made of optical plastic TPX™ (a trademark of Mitsui Petrochemicals Ltd. having a chemical form of a methylpentene copolymer) having an index of refraction n₁=1.46. In this case, the minimum thickness h of the device 500 or 600 may be reduced to about 2.68 mm if B=16 mm because the critical observation angle α_{CR} is reduced to 9.5°.

In another implementation, the optical plate 505 or 605 may be made using a material that includes Butyrate having an index of refraction n₁=1.47. In this case, the minimum thickness h₁ may be practically reduced to 3.5 mm or theoretically reduced to 3.28 mm. A size of the fingerprint image to be captured by the imaging system is approximately B=16 mm.

Therefore, the minimum size of the optical plate is limited if the index of refraction of the optical plate is greater than the index of refraction of the finger skin because the fingerprint image disappears when the observation angle α_{1,2} (measured relative to the surface 507 or 607) reaches the critical observation angle α_{CR}=90°−θCR2. This problem may be eliminated when using an optical plate made of any material having an index of refraction n₁ less than the index of refraction of the finger, that is, less than 1.44. In this case, the light rays striking the ridges of the finger are reflected. Materials having indices of refraction less than 1.44 include silicone materials, which have indices of refraction reaching 1.40 or less. Accordingly, the optical plate 505 or 605 may be made of a material including a silicone and having an index of refraction n₁=1.41.

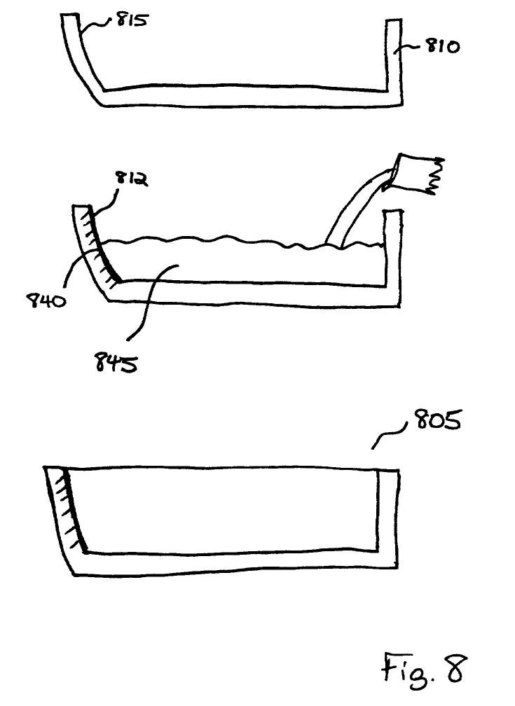

Silicone materials, because of their physical properties, are difficult to join with other optical materials such as mirrors. Thus, when using silicone materials in the optical plate 505, 605, the reflective surfaces 540, 640 and the optical plate 505, 605 are formed using techniques shown in FIGS. 7 and 8.

In FIG. 7, an optical plate 705 is first cast of a silicone material in a mold. The optical plate 705 includes a surface 707 for receiving the finger. Then, a spherically-shaped reflective surface 740 is formed as a mirror 745 separately from the optical plate 705. The reflective surface 740 is then pressed tightly (or sealed using transparent glue) to a surface 750 of the optical plate 705 to form a reflective interface. The reflective interface may produce an amount of distortion of light rays striking the reflective surface 740. However, such distortion is significantly reduced because the light rays from the light source are reflected from the surface 707 and strike the reflective surface 740 at an angle near the normal of the reflective surface 740.

In FIG. 8, an optical plate 805 is formed by first forming a transparent hollow device 810 such as a tray. The tray generally has three sides as shown. Then, a coating is applied to an inner surface 815 of one of the sides of the tray 810 to form a spherically-shaped reflective surface 840 on that side. Next, a silicone material 845 is discharged or poured into the tray 810 and then hardened to form the optical plate 805. The interface between the hardened silicone and the surface 815 may produce an insignificant amount of distortion, as described above.

A number of implementations have been described. Nevertheless, it will be understood that various modifications may be made without departing from the spirit and scope of the invention. For example, advantageous results still could be achieved if steps of the disclosed techniques were performed in a different order and/or if components in the disclosed systems were combined in a different manner and/or replaced or supplemented by other components. Accordingly, other embodiments are within the scope of the following claims.

For example, the light sources of the fingerprint imaging device may be light-emitting bars or compact filament lamps.

What is claimed is:

1. An imaging device comprising:
an optical plate made of an optically transparent material and forming a surface for receiving a finger;
a light source positioned to illuminate the finger receiving surface;
an imaging system positioned to receive light collected from the finger receiving surface and to form an image of a fingerprint pattern of the finger based on the received light;
in which the optical plate has an index of refraction less than 1.49.

2. The device of claim 1 in which the optical plate material includes TPX.

3. The device of claim 1 in which the optical plate material includes Butyrate.

4. The device of claim 1 in which the optical plate material includes silicone.

5. The device of claim 1 in which the light source is positioned at a second surface of the optical plate.

6. The device of claim 5 further including a reflective surface positioned at a third surface of the optical plate to collect light from the finger receiving surface and to focus the collected light on the imaging system.

7. The device of claim 6 in which the imaging system is positioned at a fourth surface of the optical plate.

8. The device of claim 1 in which the optical plate has an index of refraction less than 1.44.

9. The device of claim 1 in which the imaging system comprises:
an aperture at a second surface of the optical plate;
an objective at the aperture; and
a detector for receiving light collected by the aperture and the objective to form the image of the fingerprint pattern.

10. The device of claim 9 in which the imaging system comprises a reflective surface positioned between the objective and the detector for collecting light from the objective and for focusing the light onto the detector.

11. The device of claim 9 in which the detector comprises a CCD.

12. The device of claim 9 in which the detector comprises a CMOS sensor.

13. The device of claim 9 in which the aperture defines an aperture beam of light rays used by the detector to form the fingerprint pattern image.

14. An imaging device comprising:
an optical plate made of an optically transparent material and forming a surface for receiving a finger having an index of refraction;
a light source positioned to illuminate the finger receiving surface;
an imaging system positioned to receive light from the finger receiving surface and to form an image of a fingerprint pattern of the finger based on the received light;
in which the optical plate has an index of refraction less than the index of refraction of the finger.

15. The device of claim 14 in which the optical plate includes silicone.

16. An optical plate for use in imaging a fingerprint, the optical plate comprising:
an optically transparent material that forms a surface for receiving a finger;
a second surface for coupling to an imaging system that receives light collected from the finger receiving surface and that forms an image of a fingerprint pattern of the finger based on the received light; and
a third surface for coupling to a light source that illuminates the finger receiving surface;
in which the optical plate has an index of refraction less than 1.49.

17. A method of imaging a fingerprint, the method comprising:
providing an optical plate made of an optically transparent material having an index of refraction less than 1.49, the optical plate having a surface for receiving a finger;
receiving a finger at the finger receiving surface;
illuminating the finger receiving surface with a light source;
collecting light reflected from the finger receiving surface; and
receiving the collected light at an imaging system to form an image of a fingerprint pattern of the finger based on the received light.

18. A method of imaging a fingerprint, the method comprising:
providing an optical plate made of an optically transparent material having an index of refraction, the optical plate having a surface for receiving a finger;
receiving a finger at the finger receiving surface, the finger having an index of refraction;
illuminating the finger receiving surface with a light source;
collecting light reflected from the finger receiving surface; and
receiving the collected light at an imaging system to form an image of a fingerprint pattern of the finger based on the received light;
in which the index of refraction of the optical plate is less than the index of refraction of the finger.

19. A method of forming an optical plate, the method comprising:
molding a silicone material into a base;
forming a reflective device; and
attaching the reflective device to the base to form a reflective interface between the base and the reflective device.

20. A method of forming an optical plate, the method comprising:
forming a transparent hollow device having sides;
applying a coating to an inner surface of one of the sides to form a reflective surface on that side;
dispensing silicone material into the hollow device; and
hardening the silicone material to form the optical plate.
